(19) United States
(12) Patent Application Publication
(10) Pub. No.: US 2014/0364160 A1
(43) Pub. Date: Dec. 11, 2014

(54) SYSTEM AND METHOD FOR TRANSPORTING COMPATIBLE CONTENT

(71) Applicant: Kyung-hoan Shin, Seoul (KR)

(72) Inventor: Kyung-hoan Shin, Seoul (KR)

(21) Appl. No.: 14/346,394

(22) PCT Filed: Mar. 5, 2012
(86) PCT No.: PCT/KR2012/001600

§ 371 Date: Aug. 22, 2014

(30) Foreign Application Priority Data
Sep. 22, 2011 (KR) 10-2011-0095636

(51) Int. Cl. H04W 4/14; H04L 12/58

(52) U.S. Cl. CPC H04W 4/14; H04L 51/066; H04L 51/10
USPC 455/466

(57) ABSTRACT

A system for transporting compatible content provides a messenger terminal that connects to a mobile messenger application, transports a mobile message to a converting server, and receives a second short message service (SMS) or second multimedia message service (MMS) message that has been converted to be displayable; a converting server that receives the mobile message, converts the received mobile message to a first SMS message or first MMS message, transmits the converted first SMS or MMS message to a mobile terminal, receives a second SMS or MMS message from the mobile terminal, converts the second SMS or MMS message to be displayable by the mobile messenger application, and transports the converted second SMS or MMS message to the messenger terminal; and a mobile terminal that receives the first SMS or MMS message from the converting server and transports the second SMS or MMS message to the converting server.

### TECHNICAL FIELD

The present invention relates to a system and method for transmitting compatible contents, and more particularly, to a system and method for transmitting compatible contents, which can conveniently exchange contents such as a text message and the like in real-time between a user using a mobile messenger and a user who does not use a mobile messenger by converting the contents such as a text message and the like transmitted through a mobile messenger application and transmitting the converted contents to a smart phone or an existing mobile terminal in which a mobile messenger application is not installed, and maximize convenience of the users by separately displaying a dialogue counterpart who connects to a mobile messenger service, a dialogue counterpart who does not connect to the mobile messenger service, and a dialogue counterpart who does not use the mobile messenger service by the mobile messenger application.

### BACKGROUND ART

Recently, mobile messengers capable of exchanging contents for free among mobile communication terminal users are spotlighted.

The mobile messenger means a software which provides a chatting service for allowing a plurality of users to chat to each other using text, voice or the like, a data transmission service for allowing a user to exchange a variety of data such as a still image, a moving image, music and the like with a counterpart user, an information providing service for providing various kinds of information such as news, weather, e-mail and the like, and a message transmission service for transmitting an SMS message to a mobile communication terminal.

Such a mobile messenger is installed in a mobile communication terminal, and a user may conveniently use a service such as chatting, data transmission, information provision, message transmission or the like through the mobile messenger. Hereinafter, the services such as chatting, data transmission, information provision, message transmission and the like will be generally referred to as a mobile messenger service for the sake of convenience.

The mobile messenger service is generally provided in the form of a platform (WIPI) application or an OEM (terminal SW) application. Each of the applications provides a function capable of selecting a dialogue counterpart using an address book (e.g., a buddy list or the like) supported by itself.

However, in order for a user to have a dialogue with a counterpart using a mobile messenger service, the mobile messenger application should also be installed in a mobile communication terminal of the counterpart. Otherwise, the user cannot use the mobile messenger service to have a dialogue with the counterpart using the mobile messenger.

Meanwhile, although smart phones capable of installing the mobile messenger are widely distributed recently, it is true that a large number of users still use an existing mobile terminal, but not a smart phone, i.e., a mobile terminal which cannot install the mobile messenger. There is a problem in that a text messaging service provided by the existing mobile terminal is incompatible to the mobile messenger service.

In relation to the mobile messenger service, Korean Patent Laid-Open Publication No. 2011-0011837 entitled “Method of providing mobile messenger service and portable terminal using thereof” discloses a method of providing a mobile messenger service including the steps of: connecting to a mobile messenger server; displaying a dialogue window for having a dialogue with a user terminal who has connected to the mobile messenger server and transmitting and receiving a message; receiving a notification informing that the user terminal transmitting and receiving the message has released the connection to the mobile messenger server from the mobile messenger server; displaying a short message service (SMS) or a multimedia message service (MMS) message creation window; and transmitting an SMS or MMS message created according to input of a user to the user terminal which has released the connection.

However, since Korean Patent Laid-Open Publication No. 2011-0011837 is merely a technique that separately supports an SMS or MMS creation window to finish a dialogue using a text message although a user among users engaged in the dialogue using the mobile messenger service releases the connection to the mobile messenger, there always exists a problem in that it is impossible to have a dialogue in real-time with a user of a smart phone or an existing mobile terminal in which a mobile messenger application is not installed.

### DISCLOSURE OF INVENTION

### Technical Problem

The present invention has been made to solve the above-mentioned problems associated with the prior art, and it is an object of the present invention to conveniently exchange contents such as a text message and the like in real-time between a user using a mobile messenger and a user who does not use a mobile messenger by converting the contents such as a text message and the like transmitted through a mobile messenger application and transmitting the converted contents to a smart phone or an existing mobile terminal in which a mobile messenger application is not installed.

Another object of the present invention is to maximize, in exchanging contents such as a text message and the like in real-time between a user using a mobile messenger and a user who does not use a mobile messenger, convenience of the users by guaranteeing a right of the users to select a dialogue counterpart by separately displaying a dialogue counterpart who connects to a mobile messenger service, a dialogue counterpart who does not connect to the mobile messenger service, and a dialogue counterpart who does not use the mobile messenger service by the mobile messenger application.

### Technical Solution

The present invention is directed to a system for transmitting compatible contents, the system including: a messenger terminal for connecting to an installed mobile messenger application to transmit a mobile message to a conversion server and receive a second short message service (SMS) message or a second multimedia message service (MMS) message converted to be displayed by the mobile messenger application from the conversion server; the conversion server for receiving the mobile message from the messenger terminal, converting the received mobile message into a first SMS or MMS message, transmitting the converted first SMS or MMS message to a mobile terminal, receiving the second SMS or MMS message from the mobile terminal, converting the received second SMS or MMS message to be displayed by the mobile messenger application, and transmitting the converted message to the messenger terminal; and the mobile terminal for receiving the first SMS or MMS message from the conversion server and transmitting the second SMS or MMS message to the conversion server.

Preferably, the messenger terminal may include a function of separately displaying, information on current mobile messenger users, information on offline mobile messenger users, and information on users who do not use a mobile messenger, on a screen for executing the mobile messenger application.

Also, preferably, the conversion server may include a function of receiving an SNS message from a separate SNS server, converting the received SNS message into a third SMS or MMS message, transmitting the converted third SMS or MMS message to the mobile terminal, receiving a fourth SMS or MMS message from mobile terminal, converting the received fourth SMS or MMS message to be displayed through a web page provided by the separate SNS server, and transmitting the converted fourth SMS or MMS message to the separate SNS server.

In the meantime, present invention is directed to a method of transmitting compatible contents, the method including the steps of: (A) allowing a conversion server to receive a mobile message from a messenger terminal connecting to a mobile messenger application; (B) allowing the conversion server to convert the received mobile message into a first SMS or MMS message and transmit the converted first SMS or MMS message to a mobile terminal; (C) allowing the conversion server to receive a second SMS or MMS message from the mobile terminal; and (D) allowing the conversion server to convert the received second SMS or MMS message to be displayed by the mobile messenger application and transmit the converted second SMS or MMS message to the messenger terminal 100.

Preferably, the method may further include, before step (A), the step of (A-1) allowing the messenger terminal 100 to separately display information on current mobile messenger users, information on offline mobile messenger users, and information on users who do not use a mobile messenger on a screen for executing the mobile messenger application.

### Advantageous Effects

The present invention has an advantageous effect in that contents such as a text message and the like can be conveniently exchanged in real-time between a user using a mobile messenger and a user who does not use a mobile messenger by converting the contents such as a text message and the like transmitted through a mobile messenger application and transmitting the converted contents to a smart phone or an existing mobile terminal in which the mobile messenger application is not installed.

In addition, the present invention has an advantageous effect in that when contents such as a text message and the like are exchanged in real-time between a user using a mobile messenger and a user who does not use a mobile messenger, convenience of a user can be maximized by guaranteeing a right of the users to select a dialogue counterpart by separately displaying a dialogue counterpart who connects to a mobile messenger service, a dialogue counterpart who does not connects to the mobile messenger service, and a dialogue counterpart who does not use the mobile messenger service by the mobile messenger application.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram showing the entire configuration of a system for transmitting compatible contents according to a preferred embodiment of the present invention;

FIG. 2 is a reference view illustrating a method of displaying a mobile messenger address book on a messenger terminal according to a preferred embodiment of the present invention;

FIG. 3 is a reference view illustrating a method of inducing a visible satellite using three-dimensional geographic information; and

FIG. 4 is a flowchart showing the entire control operation of a method of transmitting compatible contents according to a preferred embodiment of the present invention.

### BEST MODE FOR CARRYING OUT THE INVENTION

Prior to the description, the terms or words used in the specification and the claims of the present invention should not be construed as being typical or dictionary meanings, but should be construed as meanings and concepts conforming to the technical spirit of the present invention on the basis of the principle that an inventor can properly define the concepts of the terms in order to describe his or her invention in the best way.

In the following description, the detailed description on known function and constructions unnecessarily obscuring the subject matter of the present invention will be avoided hereinafter.

Hereinafter, a system for transmitting compatible contents according to a preferred embodiment of the present invention will be described in more detail with reference to the accompanying drawings.

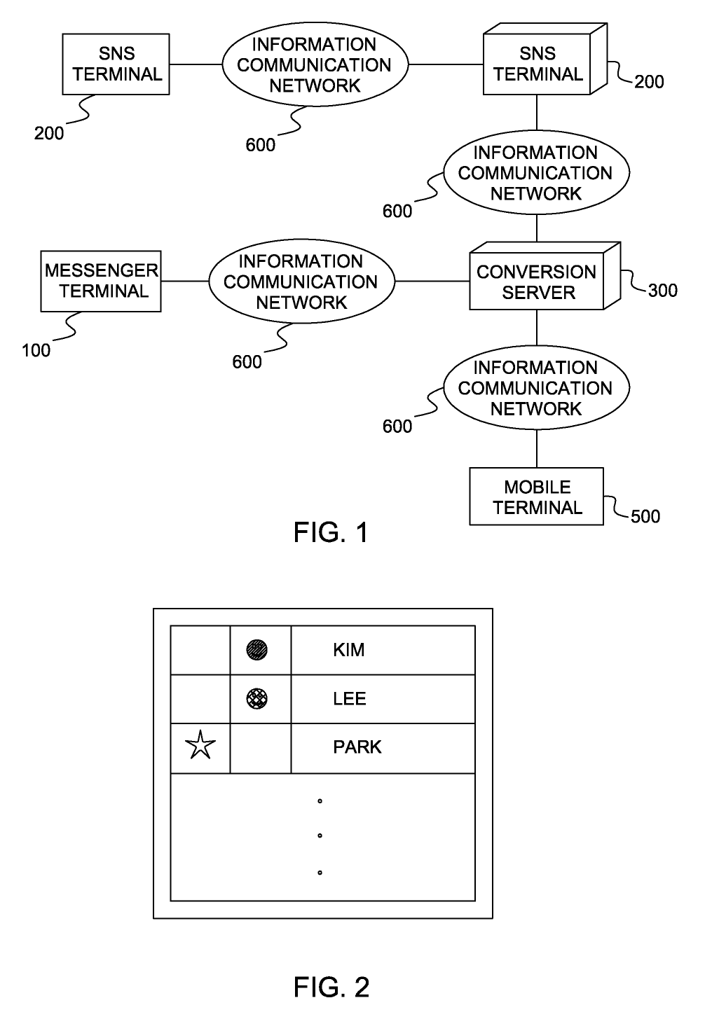

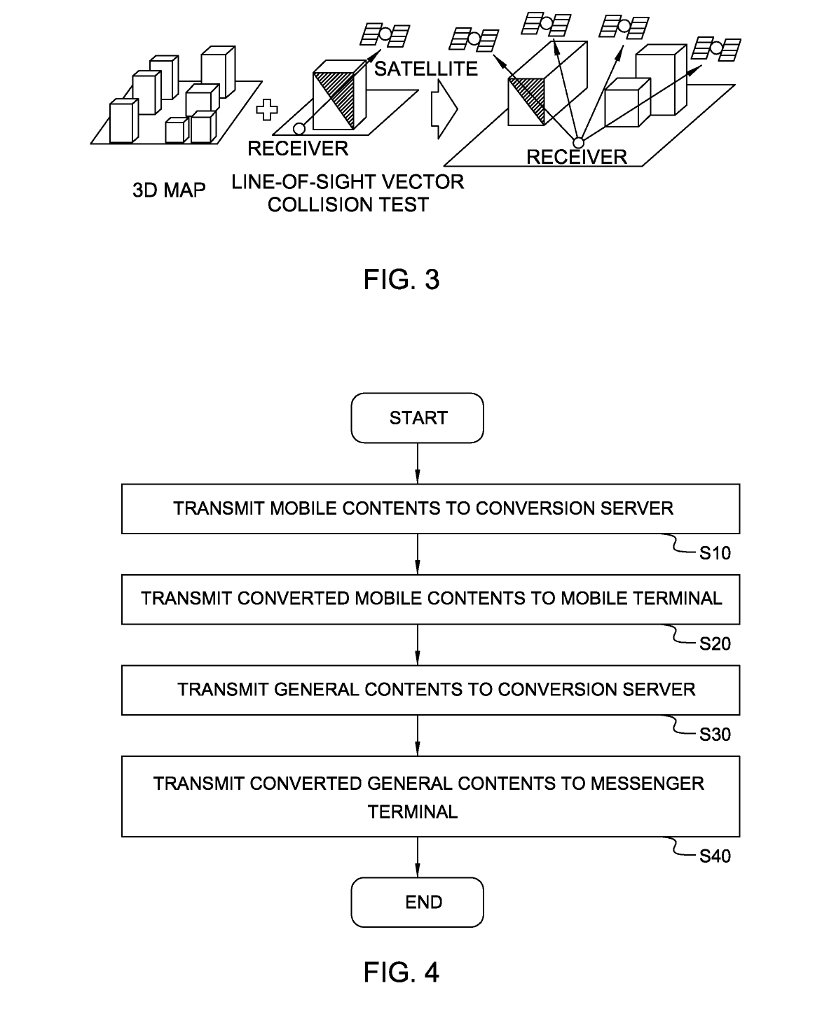

FIG. 1 is a block diagram showing the entire configuration of a system for transmitting compatible contents according to a preferred embodiment of the present invention, FIG. 2 is a reference view illustrating a method of displaying a mobile messenger address book on a messenger terminal according to a preferred embodiment of the present invention, and FIG. 3 is a reference view illustrating a method of inducing a visible satellite using three-dimensional geographic information.

As shown in FIG. 1, the system for transmitting compatible contents according to a preferred embodiment of the present invention includes a messenger terminal 100, an SNS terminal 200, a conversion server 300, an SNS server 400, a mobile terminal 500, and an information communication network 600.

First, the messenger terminal 100 is a terminal of a mobile messenger user in which a mobile messenger application is installed, and transmits mobile contents such as a mobile message or the like to the conversion server 300 through execution of the mobile messenger application and receives converted general contents such as a general text message (SMS or MMS message) or the like converted to be executed and displayed by the mobile messenger application from the conversion server 300.

The messenger terminal 100 may be regarded as a smart phone which can install and execute a variety of mobile messenger applications, and it will be understood that mobile contents are contents for which a variety of mobile messenger applications support the mobile messenger server to execute transmission and reception or the like of the mobile contents, and the general contents are contents for which a conventional mobile messenger does not support transmission and reception.

In the present invention, the mobile messenger application means software installed in a mobile communication terminal of auser and implementing a chatting service, a data transmission service, an information providing service, a message transmission service and the like.

The messenger terminal 100 is provided with a display unit, and the display unit displays information related to the mobile messenger according to execution of the mobile messenger application.

Particularly, referring to FIG. 2, when a user of the messenger terminal 100 connects to the mobile messenger and confirms an address book supported by the mobile messenger application, the display unit separately displays current mobile messenger users and offline messenger users and, particularly, additionally displays users in an address book supported by a mobile communication company server (users who do not use the mobile messenger) on the mobile terminal 500 or the like in which a mobile messenger application cannot be installed.

That is, since the user of the messenger terminal 100 may conveniently confirm users in an address book supported by a mobile communication company server (users who do not use the mobile messenger), as well as a dialogue counterpart using the mobile messenger, on the mobile messenger application if the user connects to the mobile messenger, the user of the messenger terminal 100 may instantly select a user desired to have a dialogue with, including the user who doest not use the mobile messenger or the users stored in the address book.

Such a display is implemented by providing information on an address book stored and supported by the mobile communication company server, in addition to information on an address book stored and supported by the mobile messenger server, to the messenger terminal 100 by the conversion server 300.

In FIG. 2, information on a current mobile messenger user (00 Kim) is displayed in a chromatic color, information on an offline messenger user (00 Lee) is displayed in an achromatic color, and information on a user who does not use the mobile messenger (00 Park) is expressed by displaying a special symbol at a corresponding item. However, it is apparent that the present invention is not limited thereto.

Next, the SNS terminal 200 is a terminal of a user connecting to the SNS server 400 and using an SNS service, and transmits SNS contents such as an SMS message or the like to the SNS server 400 through a web page provided by the SNS server 400 and receives general contents such as a general text message or the like converted to be displayed through a web page provided by the SNS server 400 from the SNS server 400.

Next, the conversion server 300 is a server of a company which provides a compatible contents transmission service according to a preferred embodiment of the present invention, and receives mobile contents such as a mobile message or the like from the messenger terminal 100, creates converted mobile contents converted from the received mobile contents, and transmits the converted mobile contents to the mobile terminal 500.

In addition, the conversion server 300 receives general contents such as a general text message or the like from the mobile terminal 500, creates converted general contents converted from the received general contents, and transmits the converted general contents to the messenger terminal 100.

It will be understood that the converted mobile contents are mobile contents converted in a form which can be supported even in a smart phone or an existing mobile terminal in which a mobile messenger application is not installed, and the converted general contents are general contents converted in a form which can be supported by a mobile messenger application.

In addition, the conversion server 300 receives SNS contents from the SNS server 400, transmits the received SNS contents to the mobile terminal 500, receives general contents such as a general text message or the like from the mobile terminal 500, converts the received general contents to be displayed through a web page provided by the SNS server 400, and transmits the converted contents to the SNS server 400.

In the present invention, although the conversion server 300 may be understood as a server that integrates related functions among the functions of a mobile messenger server and the functions of a mobile communication company server and performs the integrated functions, the present invention is not limited thereto, and the conversion server 300 may be configured to include the mobile messenger server and the mobile communication company server instead of the conversion server 300.

Additionally, conversion between a mobile message and an SMS or MMS message conducted by the conversion server 300 may be implemented by sharing Application Programming Interface (API) information. That is, the conversion server 300 may store API information related to the mobile message and the SMS or MMS message which will be converted and convert the mobile message into the SMS or MMS message, and vice versa, based on the API information.

Meanwhile, the conversion server 300 includes a function of searching for position information of the messenger terminal 100 and transmitting a result of searching for the position information and credibility on the position to the messenger terminal 100 periodically or when a request of providing the position information is received from the messenger terminal 100.

To this end, a position information search unit of the conversion server 300 acquires position information of the messenger terminal 100 using position coordinates of a satellite and position coordinates of a user received from the messenger terminal 100, calculates position credibility of the messenger terminal 100, and transmits a result of searching for the position information and the position credibility of the messenger terminal 100 to the messenger terminal 100.

In addition, the messenger terminal 100 includes a GNSS receiver, and the GNSS receiver derives position coordinates of a satellite based on trajectory information of the satellite (ephemeris) received after connecting to the satellite through an information communication network including the separate navigation satellite and wired and wireless networks and derives position coordinates of the user based on the derived position coordinates of the satellite.

Although a method of periodically or irregularly transmitting an SMS or MMS message is preferable as a method of the position information search unit for transmitting a result of searching for the position information to the messenger terminal 100, it is limited thereto.

The position information search unit includes a satellite signal verification means, a visible satellite calculation means, a control means, a DOP calculation means and a position credibility calculation means.

Among these, the satellite signal verification means receives position coordinates of a satellite and coordinates of a user from the messenger terminal 100, calculates an angle formed between the horizon and the satellite based on the received position coordinates of the satellite and coordinates of the user, and separates only the position coordinates of a satellite existing over the horizon since position coordinates of a satellite positioned under the horizon cannot be received as a result of the calculation.

Next, the visible satellite calculation means connects the separated position coordinates of the satellite and the position coordinates of the user with a straight line, and position information of a visible satellite is created by indexing three-dimensional geographic information corresponding to the connected position coordinates of the satellite and position coordinates of the user and classifying the position coordinates of a satellite connected using a straight line without being interfered with obstacles (buildings or the like) shown in the indexed three-dimensional geographic information as position coordinates of the visible satellite.

Specifically, referring to FIG. 3, 1) obstacles around the coordinates of the current position of a user in the three-dimensional geographic information are rendered into a three-dimensional structure using height information, 2) position coordinates of a satellite at the current time point is calculated using trajectory information received from the satellite, 3) a line-of-sight vector of the position coordinates of the satellite and the position coordinates of the user is configured, and 4) a visible satellite is identified by examining whether or not the line-of-sight vector collides with the obstacles.

In addition, the visible satellite calculation means creates multi-path satellite position information by classifying position coordinates of a satellite interfered with the obstacles shown in the indexed three-dimensional geographic information using a multi-path reception satellite that can receive the position coordinates of the satellite in the form of multiple paths.

Specifically, 1) a visible satellite that can be received at the current position is identified from the three-dimensional geographic information, 2) a satellite actually received by the GNSS receiver of the messenger terminal 100 is compared with the satellite identified as being able to be received based on the three-dimensional geographic information, and 3) a satellite actually received but determined as being unable to be received in a calculation based on the three-dimensional geographic information is derived as a satellite received through multiple paths.

Next, the control means determines whether or not raw data are accessible and, if the raw data are accessible, derives correct position coordinates of the user by recalculating the position coordinates of the user based on the position information of the visible satellite excluding the multi-path satellite position information.

Next, the DOP calculation means receives the position coordinates of the user, which is recalculated based on the position information of the visible satellite from the control means and creates information on a visible satellite position error by calculating an error affecting determination of a position by the relative geometry of the visible satellites recalculated through DOP operation.

At this point, it is desirable to understand that information on the visible satellite position error is information on an error of the position coordinates of the user expressed as a number within a preset error range from the position information of the visible satellite.

In addition, if the recalculated position coordinates of the user are not received from the control means, i.e., the control means is inaccessible to the raw data, the DOP calculation means creates information on a satellite position error by performing a DOP operation based on the position information of the visible satellite and the position information of the multi-path satellite created by the visible satellite calculation means. Finally, the position credibility calculation means receives information on the visible satellite position error or information on the satellite position error from the DOP calculation means and calculates position credibility of the messenger terminal 100 using the receive information on the visible satellite position error or information on the satellite position error.

Next, the SNS server 400 is a server of a company providing an SNS service, and receives SNS contents such as an SNS message or the like from the SNS terminal 200 and transmits general contents, such as a general text message or the like converted to be displayed on an SNS service web page to which the SNS terminal 200 is connected, to the SNS terminal 200.

In a preferred embodiment of the present invention, although the SNS server 400 is configured to be separate from the conversion server 300, the present invention is not limited thereto, and the SNS server 400 and the conversion server 300 may be configured to be integrated as one server.

Next, the mobile terminal 500 is a terminal such as an existing mobile terminal or the like in which a mobile messenger application is not installed, and receives converted mobile contents from the conversion server 300 and transmits general contents such as a general text message or the like to the conversion server 300.

The mobile terminal 500 may adopt a mobile communication scheme such as Code Division Multiple Access (CDMA), Global System for Mobile Communication (GSM), Wideband Code Division Multiple Access (WCDMA), Wireless Broadband (Wibro) or the like.

Finally, the information communication network 600 performs a function of connecting the messenger terminal 100, the SNS terminal 200, the conversion server 300, the SNS server 400 and the mobile terminal 500 to one another.

At this point, particularly, although the information communication network 600 between the messenger terminal 100 and the conversion server 300 may be a network based on a Wireless Local Area Network (WLAN), an IP Multimedia Subsystem (IMS), a Wireless Internet Platform for Interoperability (WIPI) or the like, the present invention is not limited thereto.

According to the system for transmitting compatible contents according to a preferred embodiment of the present invention as described above, a mobile messenger user may exchange a message in real-time with a user who does not use a mobile messenger on a mobile messenger application, and the user who does not use a mobile messenger may exchange a message in real-time with the mobile messenger user in the form of an SMS or MMS message.

Furthermore, a user who uses the SNS may also exchange a message in real-time with a user who does not use SNS through an SNS server, and the user who does not use SNS may confirm a message of the user who uses the SNS in real-time in the form of an SMS or MMS message.

Hereinafter, a method of transmitting compatible contents according to a preferred embodiment of the present invention will be described in detail with reference to FIG. 4.

FIG. 4 is a flowchart showing the entire control operation of a method of transmitting compatible contents according to a preferred embodiment of the present invention.

First, the messenger terminal 100 transmits mobile contents such as a mobile message and the like to the conversion server 300 through the execution of a mobile messenger application (S10).

Next, the conversion server 300 receives the mobile contents from the messenger terminal 100, converts the received mobile contents to create converted mobile contents, and transmits the converted mobile contents to the mobile terminal 500 (S20).

Subsequently, the conversion server 300 receives general contents such as a general text message (e.g., SMS or MMS message) and the like from the mobile terminal 500 and converts the received general contents to create converted general contents (S30).

Finally, the messenger terminal 100 receives the converted general contents such as a general text message or the like converted to be executed by a mobile messenger application from the conversion server 30 (S40).

While the present invention has been described in connection with the exemplary embodiments illustrated in the drawings, they are merely illustrative embodiments, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should be defined by the technical spirit of the appended claims.

1. A system for transmitting compatible contents, the system comprising:
a messenger terminal 100 for connecting to an installed mobile messenger application to transmit a mobile message and receive a second short message service (SMS) message or a second multimedia message service (MMS) message converted to be displayed by the mobile messenger application;
a conversion server 300 for receiving the mobile message from the messenger terminal 100, converting the received mobile message into a first SMS or MMS message, transmitting the converted first SMS or MMS message, receiving the second SMS or MMS message, converting the received second SMS or MMS message to be displayed by the mobile messenger application, and transmitting the converted message to the messenger terminal 100; and
a mobile terminal 500 for receiving the first SMS or MMS message from the conversion server 300 and transmitting the second SMS or MMS message to the conversion server 300.

2. The system according to claim 1, wherein the messenger terminal 100 includes a function of separately displaying information on current mobile messenger users, information on offline mobile messenger users, and information on users who do not use a mobile messenger on a screen for executing the mobile messenger application.

3. The system according to claim 1, wherein the conversion server 300 includes a function of receiving an SNS message from a separate SNS server 400, converting the received SNS message into a third SMS or MMS message, transmitting the converted third SMS or MMS message to the mobile terminal 500, receiving a fourth SMS or MMS message from mobile terminal 500, converting the received fourth SMS or MMS message to be displayed through a web page provided by the separate SNS server 400, and transmitting the converted fourth SMS or MMS message to the separate SNS server 400.

4. A method of transmitting compatible contents, the method comprising:
(A) allowing a conversion server 300 to receive a mobile message from a messenger terminal 100 connecting to a mobile messenger application;
(B) allowing the conversion server 300 to convert the received mobile message into a first SMS or MMS message and transmit the converted first SMS or MMS message to a mobile terminal 500;
(C) allowing the conversion server 300 to receive a second SMS or MMS message from the mobile terminal 500; and
(D) allowing the conversion server 300 to convert the received second SMS or MMS message to be displayed by the mobile messenger application and transmit the converted second SMS or MMS message to the messenger terminal 100.

5. The method according to claim 4, further comprising, before step (A), the step of (A-1) allowing the messenger terminal 100 to separately display information on current mobile messenger users, information on offline mobile messenger users, and information on users who do not use a mobile messenger on a screen for executing the mobile messenger application.
